(19) United States
(12) Patent Application Publication
(10) Pub. No.: US 2004/0046733 A1
(43) Pub. Date: Mar. 11, 2004

(54) Method and apparatus for keyboard entry using a handheld input device

(75) Inventors: Randolph Michael Forlenza, Austin, TX (US); Sivakumar Rajendran, Durham, NC (US); Michael Joseph Sullivan, Austin, TX (US); William J. Tracey, Round Rock, TX (US); Jonathan Mark Wagner, Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/246,930

(22) Filed: Sep. 19, 2002

(51) Int. Cl. G09G 5/00

(52) U.S. Cl. 345/156

(57) ABSTRACT

The present invention relates to a method, apparatus, and computer instructions for keyboard entry into a computer device using a handheld input device configured to be held in the palm of one hand. The handheld input device contains a thumb controlled push pad capable of eight directions plus a center position and four buttons operable by the remaining four fingers. The four buttons can be pressed in various combinations to generate up to sixteen different possible keystrokes. When pressing combinations of the four buttons in conjunction with the thumb controlled push pad, the handheld input device is capable of generating at least 144 unique keystrokes. The handheld input device is programmable to meet the needs of the application being supported and may include, for example, the same input as the standard QWERTY keyboard. A user can hold a device, such as a personal digital assistant, in one hand and the handheld input device in the other hand to generate keyboard input for the device.

### BACKGROUND OF THE INVENTION

1. Technical Field

The present invention relates to an improved data processing system. In particular, the present invention relates to a method, apparatus, and computer instructions for keyboard entry using a handheld input device.

2. Description of Related Art

Keyboard entry on some small computer devices, such as a personal digital assistant (PDA) and cell phone, is cumbersome and can be difficult. Many times the user of a computer device is standing, walking, or may not have a surface for a keyboard input device. For example, a user may be taking inventory while walking through rows of merchandise. In another example, keyboard entry is difficult for those with visual deficiencies. Keyboard entry can be difficult whether using a GUI keyboard, graffiti, or attached keyboard on a small computer device.

Certain PDA's such as a Pocket PC or Palm device have an input method, referred to as graffiti, where the user can move a stylus in an area on the display to generate a character. For example, a circle could represent the letter “o”. The graffiti input method can be time consuming and occasionally the character generated is not the character that the user intended to generate.

Often only one hand is available for keyboard input into computer devices, for example, when holding a PDA or when a user only has one hand. It is difficult and slow to use a standard QWERTY keyboard with only one hand. A QWERTY keyboard is the standard typewriter keyboard with the Q, W, E, R, T, and Y letters on the top left alphabetic row.

Keyboard input includes the standard alphanumeric typewriter keys (including punctuation, symbols, and the shift keys) and several specialized keys, such as for example, an enter key, cursor keys, a control key, an alt key, an escape key, a numeric lock key, a delete key, an insert key, a backspace key, a home key, an end key, a page up key, a page down key, and function keys. Keyboard input may also be completely programmable to meet the needs of the application being supported.

Some input devices for small computer devices have very small buttons, which are hard to press, adding to the difficulty of keyboard input. Attachable or wireless keyboard input devices are available for most computer devices. But, often a desk or other surface is not available for a computer device or a keyboard input device. A portable keyboard can be attached to a small computer device, such as a PDA, which still does not provide an easy method of keyboard entry when both hands and a flat surface are not available. It is awkward to balance and use a portable keyboard when a flat surface it not available. The BAT™ Personal Keyboard by Infogrip is a one handed, compact input device that replicates all the functions of a full sized keyboard, but is designed for a desktop rather than to be held. Therefore, it would still be very difficult to use the BAT™ Personal Keyboard while walking, standing, or holding a small computer device.

Therefore, it would be advantageous to have an improved method, apparatus, and computer instructions for keyboard entry into a computer device using a handheld input device.

### SUMMARY OF THE INVENTION

The present invention relates to a method, apparatus, and computer instructions for keyboard entry into a computer device using a handheld input device configured to be held in the palm of one hand. The handheld input device contains a thumb controlled push pad capable of eight directions plus a center position and four buttons operable by the remaining four fingers. The four buttons can be pressed in various combinations to generate up to sixteen different possible keystrokes. When pressing combinations of the four buttons in conjunction with the thumb controlled push pad, the handheld input device is capable of generating at least 144 unique keystrokes. Additional buttons may be added to increase the number of unique keystrokes. For example, each finger may be used to operate two different buttons for a total of eight buttons. The handheld input device is programmable to meet the needs of the application being supported, which may include, for example, the same input as the standard QWERTY keyboard. A user can hold a computer device, such as a personal digital assistant, in one hand and the handheld input device in the other hand to easily generate keyboard input for the computer device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the present invention may be implemented in accordance with a preferred embodiment of the present invention;

FIG. 2 shows a block diagram of a data processing system in which the present invention may be implemented in accordance with a preferred embodiment of the present invention;

FIG. 3 depicts a diagram of a client in the form of a personal digital assistant (PDA) in which the present invention may be implemented in accordance with a preferred embodiment of the present invention;

FIG. 4 is a block diagram of a PDA in which the present invention may be implemented in accordance with a preferred embodiment of the present invention;

FIGS. 5A and 5B are diagrams of a handheld input device containing four finger control buttons and a thumb control push pad in accordance with a preferred embodiment of the present invention;

FIGS. 6A, 6B, and 6C are diagrams of a handheld input device containing four finger control buttons and a thumb control push pad in accordance with a preferred embodiment of the present invention;

FIG. 7 is a diagram of a handheld input device containing eight finger control buttons and a thumb control push pad in accordance with an alternate method of the present invention;

FIG. 8 is a flowchart of the process to generate a signal from a handheld input device in accordance with a preferred embodiment of the present invention; and

FIG. 9 is a flowchart of the process for a computer device to identify keyboard input from a handheld input device in accordance with a preferred embodiment of the present invention.

### DETAILED DESCRIPTION OF THE PREFERRED EMBODIMENT

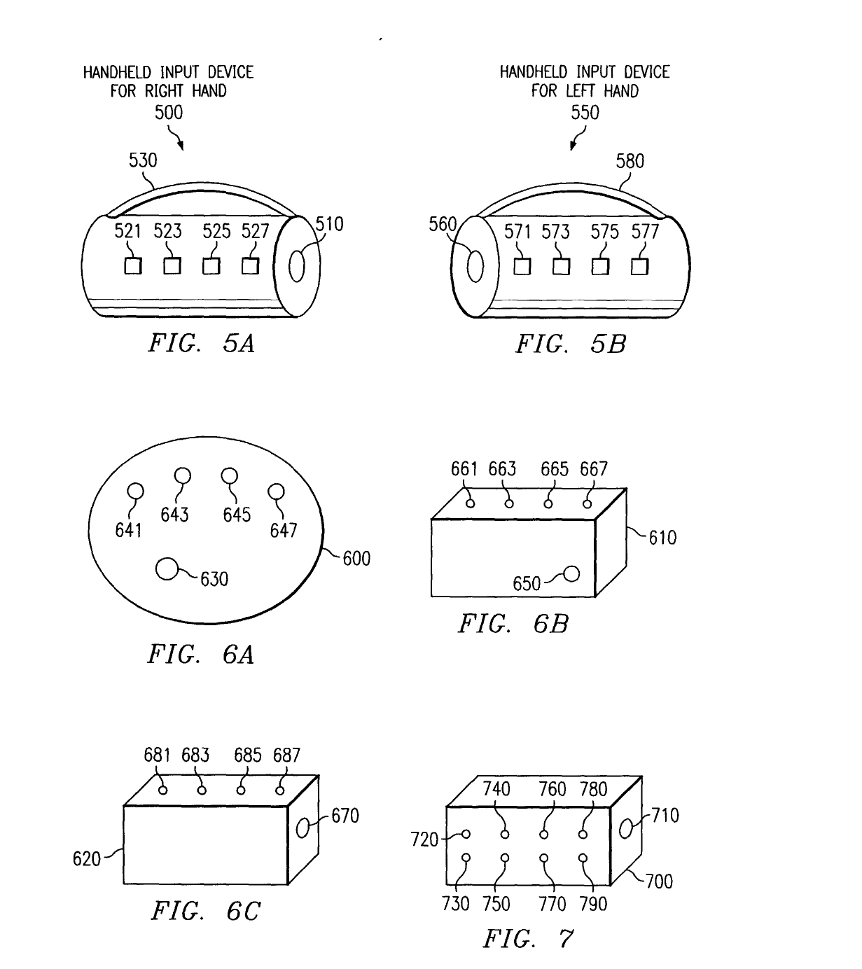

With reference now to the figures and in particular with reference to FIG. 1, a pictorial representation of a data processing system in which the present invention may be implemented is depicted in accordance with a preferred embodiment of the present invention. A computer 100 is depicted which includes a system unit 102, a video display terminal 104, a keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Keyboard 106 may be replaced with the handheld input device of the present invention described below in FIGS. 5-7.

Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

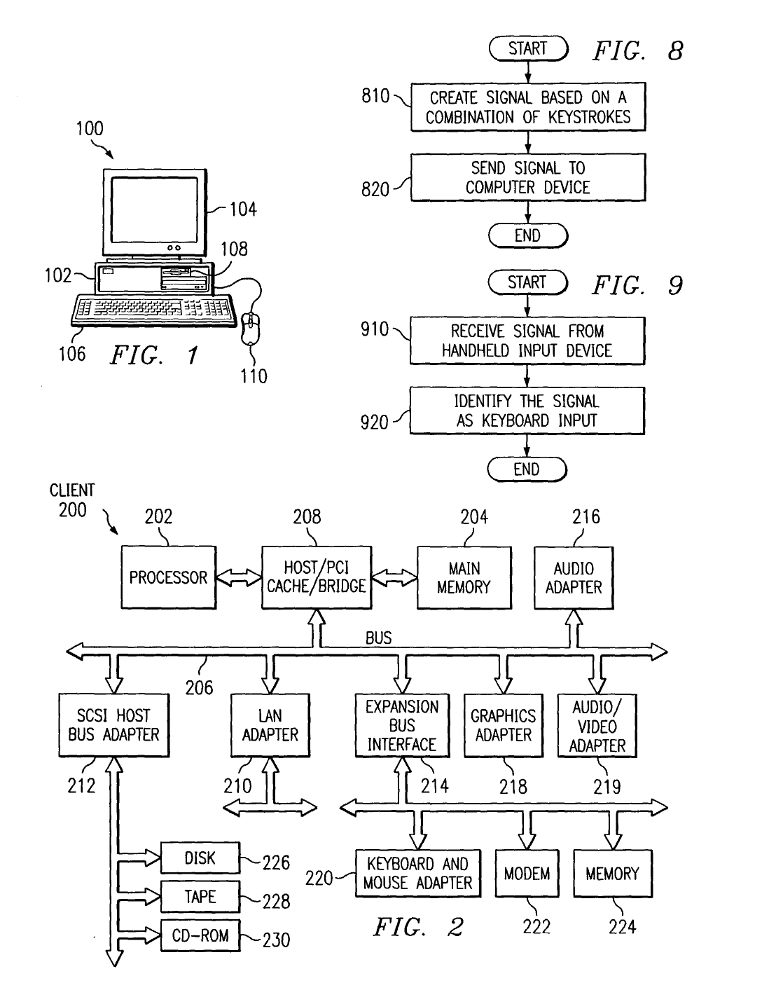

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

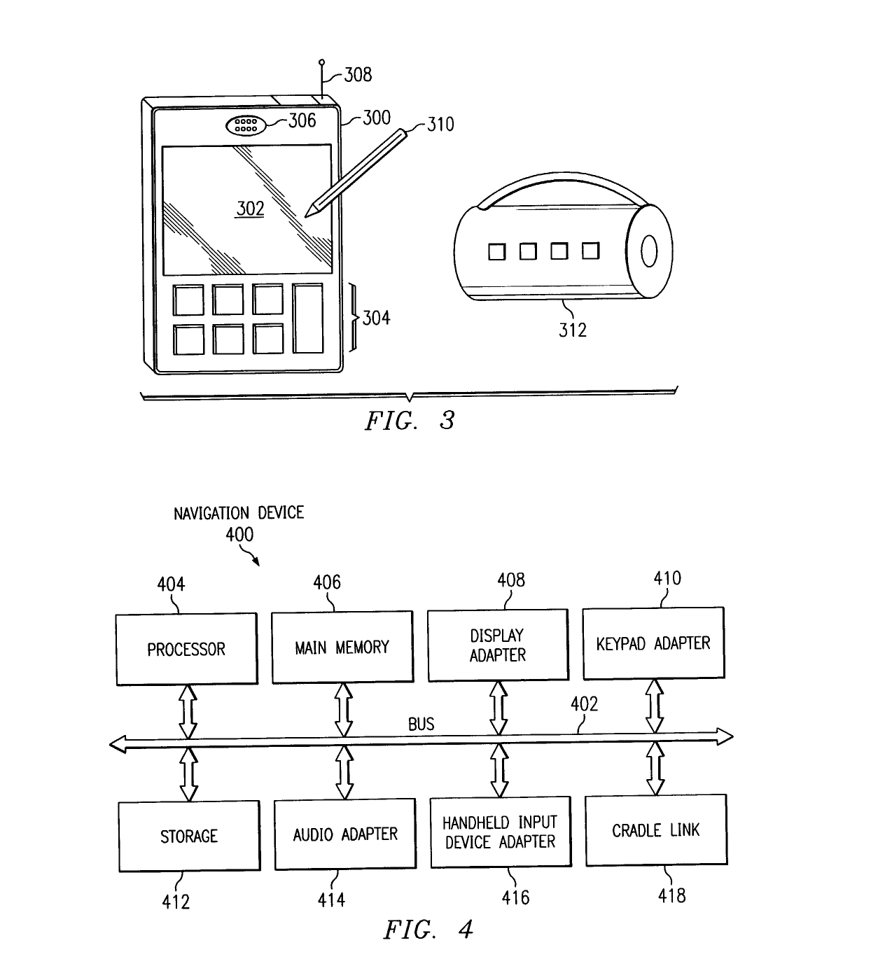

With reference now to FIG. 3, a diagram of a client in the form of a personal digital assistant (PDA) is depicted in accordance with a preferred embodiment of the present invention. PDA 300 includes a display 302 for presenting textual and graphical information. Display 302 may be a known display device, such as a liquid crystal display (LCD) device. The display may be used to present, for example, a map or directions, calendar information, a telephone directory, or an electronic mail message. In these examples, screen 302 may receive user input using an input device such as, for example, stylus 310. PDA 300 may also include keypad 304, speaker 306, and antenna 308. Keypad 304 and handheld input device 312 may be used to receive user input in addition to using screen 302. Speaker 306 provides a mechanism for audio output, such as presentation of an audio file. Antenna 308 may receive signals from handheld input device 312.

PDA 300 also preferably includes a graphical user interface that may be implemented by means of systems software residing in computer readable media in operation within PDA 300.

Turning now to FIG. 4, a block diagram of a PDA is shown in accordance with a preferred embodiment of the present invention. PDA 400 is an example of a PDA, such as PDA 300 in FIG. 3, in which code or instructions implementing the processes of the present invention may be located. PDA 400 includes a bus 402 to which processor 404 and main memory 406 are connected. Display adapter 408, keypad adapter 410, storage 412, audio adapter 414, and handheld input device adapter 416 also are connected to bus 402. Cradle link 418 provides a mechanism to connect PDA 400 to a cradle used in synchronizing data in PDA 400 with another data processing system. Further, display adapter 408 also includes a mechanism to receive user input from a stylus when a touch screen display is employed.

An operating system runs on processor 404 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

FIGS. 5A and 5B are diagrams of a handheld input device containing four finger control buttons and a thumb control push pad in accordance with a preferred embodiment of the present invention. The present invention uses an input device held in the palm of one hand. Handheld input device 500 in FIG. 5A contains a thumb control push pad, such as push pad 510. Push pad 510 is capable of multiple selections.

In the preferred embodiment of the present invention, push pad 510 has nine possible selections, which consist of the eight directional positions (North, North East, East, South East, South, South West, West, North West) and the center position. Any one of the nine positions may be selected. Handheld input device 500 also contains buttons 521, 523, 525, and 527. The four fingers control the four buttons, such as buttons 521, 523, 525, and 527. For example, since handheld input device 500 is held in the palm of the right hand, the index finger operates button 527, the middle finger operates button 525, the ring finger operates button 523, and the pinky finger operates button 521.

Handheld input device 550 in FIG. 5B is designed to be held in the left hand; therefore, thumb control push pad 560 is located on the opposite side as push pad 510 in FIG. 5A. Since handheld input device 550 is held in the palm of the left hand, the index finger operates button 571, the middle finger operates button 573, the ring finger operates button 575, and the pinky finger operates button 577. Buttons 521, 523, 525, 527, 571, 573, 575, and 577 and push pad 510 and 560 may be in the form of, for example, keys, levers, toggle switches, joysticks, touch pads, and push pads.

The four buttons on the handheld input device, such as handheld input device 500 and 550, can be pressed in various combinations to generate up to sixteen different possible keystrokes. When pressing combinations of the four buttons in conjunction with the thumb controlled push pad, the handheld input device is capable of deriving at least 144 unique keystrokes. The keystrokes generate a signal representing an alphanumeric character, function, or specialized character. The signal is sent to a computer device, such as client 100 in FIG. 1, client 200 in FIG. 2, PDA 300 in FIG. 3, and PDA 400 in FIG. 4. Handheld input device 500 and 550 may be physically attached to a computer device using an adapter, such as for example handheld input device adapter 416 in FIG. 4, or the signal may be sent to the computer device using wireless technology.

A corresponding device driver on a computer device receives the incoming signals via some connection methods such as serial port, USB, BlueTooth or some other transport mechanism. The device driver maps the signal to the corresponding keystroke and forwards the information to the operating system.

Configuration software is used to setup the mappings of the keystrokes. For example, a GUI program representing the four finger buttons and the nine thumb positions as radio buttons may be utilized to input the desired fingering position with an entry field to input the character desired when the combination of keystrokes is pressed. The input is used to generate the mappings that the device driver uses to translate the incoming signals to actual keystrokes. The keyboard input is completely programmable to meet the needs of the application being supported. Additionally, the mapping of the keystrokes may be displayed on a computer device.

Handheld input devices 500 and 550 may be secured to the palm of one hand. For example, a Velcro or elastic strap, such as strap 530 and 580, may be attached to handheld input devices 500 and 550 so that the handheld input device is held in place.

The handheld input device of the present invention may be a separate device from the computing device or may be part of the computing device. The handheld input device may be, for example, shaped as a handle that is physically attached to a PDA. The configuration of the handheld input device is exemplary and may vary depending on the implementation.

FIGS. 6A, 6B, and 6C are diagrams of a handheld input device containing four finger control buttons and a thumb control push pad in accordance with a preferred embodiment of the present invention. The shape of the handheld input device, such as handheld input device 600, 610, and 620, and handheld input device 500 and 550 in FIGS. 5A and 5B, and the location of the buttons and push pad, as shown in FIGS. 6A, 6B, and 6C, may vary. The shape of the handheld input device and the location of the buttons and push pad are designed to provide comfort and ease of use.

Handheld input device 600 is formed to fit comfortably in the palm of one hand. Push pad 630 and buttons 641, 643, 645, and 647 are arranged so that the controlling stem can easily operate the corresponding button or push pad.

Handheld input device 610 shows push pad 650 located on the front side surface and buttons 661, 663, 665, and 667 located on the top surface. Handheld input device 620 shows push pad 670 located on the right side surface and buttons 681, 683, 685, and 687 located on the top surface. The shape and location of the device, buttons, and push pad may vary depending on the implementation. The handheld input device may also contain surfaces with Braille for visually impaired users.

FIG. 7 is a diagram of a handheld input device containing eight finger control buttons and a thumb control push pad in accordance with an alternate method of the present invention. In an alternative method, additional buttons may also be added to handheld input device 700. The thumb controls push pad 710. If the handheld input device is designed for the right hand, the pinky finger controls buttons 720 and 730, the ring finger controls buttons 740 and 750, the middle finger controls buttons 760 and 770, and the index finger controls buttons 780 and 790. FIG. 7 shows that each finger can operate two different buttons, but the number of buttons operated by a stem may vary. Those of ordinary skill in the art will appreciate that the number and location of buttons on handheld input device 700 in FIG. 7 may vary depending on the implementation.

FIG. 8 is a flowchart of the process to generate a signal from a handheld input device in accordance with a preferred embodiment of the present invention.

When a user presses a combination of keys on a handheld input device, such as handheld input device 500 and 550 in FIG. 5A and 5B, a signal is created based on the keystrokes (step 810). For example, a signal, representing the letter ‘A’, may be generated when pressing the button controlled by the index finger. The signal representing the letter ‘Q’ may require pressing more than one key. Each combination of keystrokes represents an alphanumeric character, special character, or function.

In another example, the keystrokes may be programmed through binary coding. Given the possible 144 or more unique keystrokes using on/off as the binary code, the most frequent keys could have the easiest fingering position. For example, the enter key could just be the center position on the thumb control without pressing finger controlled buttons. The most frequent letters used for a given language could be a single finger button with one of the nine positions on the thumb control. It is expected that the user could configure the button combinations to whatever they please. It is envisioned that the thumb control may be the button that finalizes the keystroke sequence.

The signal created by the handheld input device is sent to a computer device (step 820) with the process terminating thereafter.

FIG. 9 is a flowchart of the process for a computer device to identify keyboard input from a handheld input device in accordance with a preferred embodiment of the present invention.

A corresponding device driver on a computer device, such as PDA 300 in FIG. 3, receives incoming signals from a handheld input device, such as for example handheld input device 312 in FIG. 3, via some connection methods such as serial port, USB, BlueTooth or some other transport mechanism (step 910).

The device driver maps the incoming signal to the corresponding keystroke and forwards the information to the operating system so that the computer device can identify the signal as keyboard input (step 920) with the process terminating thereafter.

Thus, the present invention provides an improved method, apparatus, and computer instructions for keyboard entry into a computer device using a handheld input device configured to be held in the palm of one hand. The handheld input device of the present invention is capable of generating programmable input, facilitates one-handed keystroke input without having to share display space as in the standard QWERTY keyboard, and can be used while standing, walking and when a surface is not available. Additionally, the handheld input device can be held in one hand and a small computing device can be held in the other hand to facilitate keyboard input comfortably and easily.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A handheld input device to generate keyboard input comprising:
at least four buttons; and
a control, wherein the control has two or more possible positions;
wherein the handheld input device generates a keystroke input based on manipulation of the at least four buttons and the control and wherein the handheld input device is configured to be held in a palm of one hand.

2. The apparatus of claim 1, wherein the at least four buttons are at least one of a set of keys, a set of levers, a set of toggle switches, a set of joysticks, a set of touch pads and a set of push pads.

3. The apparatus of claim 1, wherein the control is at least one of a push pad and a touch pad.

4. The apparatus of claim 1, wherein the control has eight directional positions and a center position.

5. The apparatus of claim 1, wherein each of the at least four buttons is operable by a finger.

6. The apparatus of claim 1, wherein a thumb operates the control.

7. The apparatus of claim 1, wherein a specific finger controls one of the at least four buttons.

8. The apparatus of claim 1, wherein a specific finger controls multiple of the at least four buttons.

9. The apparatus of claim 1, wherein the handheld input device is physically attached to a computer device.

10. The apparatus of claim 1, wherein the handheld input device uses wireless technology to send a signal to a computer device.

11. The apparatus of claim 1, wherein the handheld input device generates programmable input.

12. The apparatus of claim 1, wherein the handheld input device generates alphanumeric input.

13. The apparatus of claim 1, wherein the handheld input device generates the same input as a standard QWERTY keyboard.

14. The apparatus of claim 1, wherein the handheld input device is generates at least 144 unique keystrokes.

15. The apparatus of claim 1, wherein the handheld input device generates a signal by pressing the control.

16. The apparatus of claim 1, wherein the handheld input device generates a signal by pressing at least one of the at least four buttons.

17. The apparatus of claim 1, wherein the handheld input device generates a signal by pressing at least one of the at least four buttons and the control.

18. The apparatus of claim 1, wherein the handheld input device is strapped to one hand.

19. A method in a data processing system for keyboard entry into a computer device using a handheld input device, the method comprising:
receiving a signal from the handheld input device, wherein the handheld input device is configured to be held in a palm of one hand and contains at least four buttons and a control, wherein the control has two or more possible positions and wherein the handheld input device generates a keystroke input based on manipulation of the at least four buttons and the control; and
converting the signal from the handheld input device to keyboard input for the computer device.

20. A method of using a handheld input device, wherein the handheld input device comprises at least four buttons and a control, wherein the control has two or more potential positions, the method comprising:
depressing a combination of the at least four buttons; and
manipulating the control to place the control into one of the two or more potential positions;
wherein the combination of the at least four buttons and the position of the control define a given keystroke.

21. A data processing system comprising:
a processor;
a handheld input device, wherein the handheld input device comprises at least four buttons and a control, wherein the control has two or more potential positions; and
a handheld input device adapter, wherein the handheld input device adapter receives a signal from the handheld input device, wherein the signal is generated based on a selection of a combination of keystrokes from the at least four buttons and the control.

22. A computer program product in a computer readable medium for keyboard entry into a computer device using a handheld input device, the computer program product comprising:
first instructions for receiving a signal from the handheld input device, wherein the handheld input device is configured to be held in a palm of one hand and contains at least four buttons and a control, wherein the control has two or more possible positions and wherein the handheld input device generates a keystroke input based on manipulation of the at least four buttons and the control; and
second instructions for converting the signal from the handheld input device to keyboard input for the computer device.
